(19) United States
(12) Patent Application Publication
(10) Pub. No.: US 2020/0163370 A1
(43) Pub. Date: May 28, 2020

(54) LIQUID NUTRITIONAL COMPOSITIONS INCLUDING GREEN TEA EXTRACT AND IRON

(71) Applicant: Abbott Laboratories, Abbott Park, IL (US)

(72) Inventors: Gaurav PATEL, Gahanna, OH (US); Normanella DEWILLE, Columbus, OH (US); Suzette PEREIRA, Westerville, OH (US); Rockendra GUPTA, Columbus, OH (US)

(21) Appl. No.: 16/627,831

(22) PCT Filed: Jul. 24, 2018
(86) PCT No.: PCT/US2018/043398

§ 371 Date: Dec. 31, 2019

Related U.S. Application Data
(60) Provisional application No. 62/540,772, filed on Aug. 3, 2017.

(51) Int. Cl. A23L 33/00; A23L 33/19; A23L 33/12; A23L 2/60; A23L 33/165; A23L 2/66; A23L 33/125; A23L 33/105; A23L 33/185; A23L 2/56

(52) U.S. Cl. CPC A23L 33/30; A23L 33/19; A23L 33/12; A23L 2/60; A23L 2/56; A23L 2/66; A23L 33/125; A23L 33/105; A23L 33/185; A23L 33/165

(57) ABSTRACT

A sterilized liquid nutritional composition has an off-white color and a pH of from about 6 to 7.5 and comprises a source of protein, a source of fat, a source of carbohydrate, green tea extract comprising epigallocatechin gallate (EGCg), and an insoluble source of iron comprising at least one of ferric orthophosphate and ferric pyrophosphate. The liquid nutritional composition comprises, per 237 ml serving, from about 50 to 500 mg green tea extract and from about 6 to 60 mg ferric orthophosphate and/or ferric pyrophosphate, and has a Hunter L value not less than 60.

### FIELD OF THE INVENTION

This invention is directed to liquid nutritional compositions including green tea extract and iron, and, more specifically, liquid nutritional compositions including epigallocatechin gallate (EGCg) and iron which have an off-while color and exhibit good color stability.

### BACKGROUND OF THE INVENTION

The advantageous effects of green tea are known in the art. Various disclosures have described green tea as providing improved biological effects such as improving body composition and muscle, reducing body weight, reducing total and subcutaneous abdominal fat, and/or maintaining and/or improving muscle structure and strength, reducing cardiovascular disease risk by, inter alia, improving lipid profiles, reducing total and low-density lipoprotein (LDL) cholesterol without significantly effecting high-density lipoprotein (HDL) cholesterol, improving endothelial function, and/or reducing blood pressure, improving mental health and cognition, and enhancing exercise performance. Accordingly, there is a substantial interest in increasing green tea or, more specifically, green tea extract, in an individual's diet to obtain one or more of the aforementioned benefits.

The addition of green tea extracts to various food and drink products has been described. See, for example, Abbott Laboratories WO 2014/144458 A1. A particularly preferred manner for including green tea extract in an individual's diet is by inclusion in a nutritional composition such as a liquid nutritional composition. For example, Abbott Laboratories WO 2014/055905 A1 discloses liquid nutritional compositions containing at least one source of EGCg in an amount sufficient to provide 10-1000 mg of EGCg per serving. Polyphenols and catechins are the active ingredients in green tea believed to provide the various beneficial effects of green tea, with the major polyphenol in green tea being EGCg. One problem that is encountered when including green tea extracts, or, specifically, EGCg, in food products is product discoloration. For example, addition of green tea extract containing EGCg can cause a nutritional composition having a neutral pH and an off-white color, such as a vanilla-flavored nutritional composition, to become noticeably and disadvantageously discolored. Addition of green tea extract to a conventional neutral pH, vanilla-flavored nutritional composition containing iron fortification causes the composition to turn a purple or red color. The discoloration often increases when the composition is heat treated, for example, during processing and/or aseptic or retort sterilization. As consumers expect a nutritional composition to have a color which reflects the flavoring of the composition, the discoloration caused by green tea extract, or, specifically, EGCg, in such products can render the compositions unacceptable to consumers as it is incongruent with the expected flavor-associated coloring.

Accordingly, a need exists for improved nutritional compositions which can include green tea extract, or, specifically, EGCg, to provide the beneficial effects noted above, without causing discoloration which renders the compositions unacceptable to consumers.

### SUMMARY OF THE INVENTION

The present invention overcomes one or more disadvantages of the prior art and provides certain liquid nutritional compositions with improved color stability.

In one embodiment, the invention is directed to a sterilized liquid nutritional composition having an off-white color and a pH of from about 6 to 7.5 and comprising a source of protein, a source of fat, a source of carbohydrate, green tea extract comprising epigallocatechin gallate (EGCg), and an insoluble source of iron comprising at least one of ferric orthophosphate and ferric pyrophosphate. The composition comprises, per 237 ml serving, from about 50 to 500 mg green tea extract and from about 6 to 60 mg ferric orthophosphate and/or ferric pyrophosphate, and has a Hunter L value not less than 70.

It has been discovered that by providing green tea extract comprising EGCg in combination with at least one of ferric orthophosphate and ferric pyrophosphate, which are insoluble iron supplements, significant discoloration in the nutritional composition is avoided. As a result, a neutral pH nutritional composition having an off-white color can be provided with the benefits of both green tea extract and iron supplementation, while maintaining the color of the composition consistent with the composition flavoring.

These and additional objects and advantages of the invention will be more fully apparent in view of the detailed description.

### BRIEF DESCRIPTION OF THE DRAWING

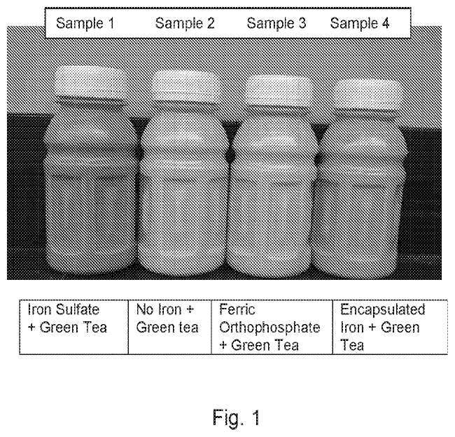

The drawing consists of FIG. 1 which illustrates an exemplary embodiment of the invention and several comparative compositions as described in the Example.

### DETAILED DESCRIPTION

In one embodiment, the invention is directed to liquid nutritional compositions. The term “liquid nutritional composition” as used herein, unless otherwise specified, encompasses all forms of nutritional liquids, including emulsified liquids, and liquids formed by reconstituting nutritional powders, for example, by addition of water. The liquid nutritional compositions are suitable for oral consumption by a human.

All percentages, parts and ratios as used herein, are by weight of the total composition, unless otherwise specified. All such weights as they pertain to listed ingredients are based on the active level and, therefore, do not include solvents or byproducts that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

Throughout this specification, when a range of values is defined with respect to a particular characteristic of the present invention, the present invention relates to and explicitly incorporates every specific subrange therein. Additionally, throughout this specification, when a group of substances is defined with respect to a particular characteristic of the present invention, the present invention relates to and explicitly incorporates every specific subgroup therein. Any specified range or group is to be understood as a shorthand way of referring to every member of a range or group individually as well as every possible subrange and subgroup encompassed therein.

The various embodiments of the nutritional compositions of the present disclosure may also be substantially free of any optional or selected ingredient or feature described herein, provided that the remaining nutritional composition still contains all of the required ingredients or features as described herein. In this context, and unless otherwise specified, the term “substantially free” means that the selected nutritional product contains less than a functional amount of the optional ingredient, typically less than 1%, including less than 0.5%, including less than 0.1%, and also including zero percent, by weight, of such optional or selected essential ingredient.

The nutritional compositions described herein may comprise, consist of, or consist essentially of the essential elements of the compositions as described herein, as well as any additional or optional elements described herein or otherwise useful in nutritional product applications.

Unless otherwise indicated herein, all exemplary embodiments, sub-embodiments, specific embodiments and optional embodiments are respective exemplary embodiments, sub-embodiments, specific embodiments and optional embodiments to all embodiments described herein.

The term “serving” as used herein, unless otherwise specified, refers to an amount which is intended to be consumed by an individual in one sitting or within one hour or less. While the invention is described with respect to a serving of 237 ml (8 ounces) of a liquid nutritional composition, the liquid nutritional compositions of the invention may be provided in smaller or larger servings as desired. It should also be recognized that a liquid nutritional composition according to the invention may comprise a reconstituted liquid composition formed from a powder nutritional composition, for example, by addition of water.

In one embodiment, the liquid nutritional compositions of the invention are shelf stable. The term “shelf stable” as used herein, unless otherwise specified, refers to a liquid nutritional composition that remains commercially stable after being packaged and then stored at 18-24° C. for at least 3 months. Such packaging will typically include heat sterilization of the composition, for example, by aseptic or retort methods. Shelf stability may be measured by any suitable indicia of stability including, but not limited to, consumer acceptance panel, sedimentation, etc.

The nutritional compositions of the invention have a neutral pH, i.e., a pH of from about 6 to 7.5. In specific embodiments, the nutritional compositions have a pH of form about 6.5 to 7.2 or, more specifically, from about 6.8 to 7.1.

The liquid nutritional compositions, including reconstituted liquid compositions formed from a powder nutritional composition, may have a variety of product densities, but most typically the liquid compositions will have a density greater than about 1.055 g/ml, including from 1.06 g/ml to 1.12 g/ml, and also including from about 1.085 g/ml to about 1.10 g/ml.

The nutritional compositions of the invention contain a macronutrient profile of protein, fat and carbohydrate. Although total concentrations or amounts of the protein, fat, and carbohydrate may vary depending upon the product type (i.e., dietary supplement, medical food, human milk fortifier, infant formula, toddler formula, etc.) and targeted dietary needs of the intended user, such concentrations or amounts most typically fall within one of the following embodied ranges, inclusive of any other protein, fat, and/or carbohydrate ingredients as described herein.

Protein

The nutritional compositions described herein include a source or sources of protein. Any protein source that is suitable for use in oral liquid nutritional compositions and is compatible with the essential elements and features of such compositions is suitable for use herein. Exemplary sources of the protein include, but are not limited to, whole egg powder, egg yolk powder, egg white powder, whey protein, whey protein concentrate, whey protein isolate, whey protein hydrolysate, acid casein, casein protein isolates, sodium caseinate, calcium caseinate, potassium caseinate, casein hydrolysate, milk protein concentrate, milk protein isolate, milk protein hydrolysate, nonfat dry milk, whole cow's milk, partially or completely defatted milk, coconut milk, soy protein concentrate, soy protein isolate, soy protein hydrolysate, pea protein concentrate, pea protein isolate, pea protein hydrolysate, rice protein concentrate, rice protein isolate, rice protein hydrolysate, collagen protein, collagen protein hydrolysate, meat proteins such as beef protein isolate and/or chicken protein isolate, or a combination of two or more thereof.

The amount of protein present in the nutritional composition can vary widely and may be based on the particular needs of the intended consumer or the intended product form. In certain exemplary embodiments, protein is present in an amount of 5 g to 25 g per serving (e.g., approximately 8 oz. or 237 ml) of the nutritional composition. In certain exemplary embodiments, protein is present in an amount of 5 to 20 g, or, more specifically, 5 g to 15 g, per 237 ml serving of the nutritional composition. In certain exemplary embodiments, protein is present in an amount of 6 g to 15 g per 237 ml serving of the nutritional composition. In certain exemplary embodiments, protein is present in an amount of 7 g to 10 g per 237 ml serving of the nutritional composition. In certain exemplary embodiments, protein is present in an amount of about 9 g per 237 ml serving of the nutritional composition. In certain exemplary embodiments, protein is present in an amount of about 0.03-0.05 g per ml of the nutritional composition.

Fat

The nutritional compositions described herein include a source or sources of fat. Suitable sources of fat for use herein include any fat or fat source that is suitable for use in an oral liquid nutritional composition and is compatible with the essential elements and features of such compositions. Exemplary sources of the fat include, but are not limited to, whole egg powder, egg yolk powder, egg white powder, coconut milk, coconut oil, fractionated coconut oil, soy oil, corn oil, butter oil, olive oil, safflower oil, high oleic safflower oil, high gamma-linolenic acid (GLA) safflower oil, medium chain triglycerides, sunflower oil, high oleic sunflower oil, palm oil, palm kernel oil, palm olein, canola oil, algae oil, borage oil, marine oil, fish oil, cottonseed oil, a structured lipid, any of said oils in powder form, or a combination of two or more thereof.

The amount of fat present in the nutritional composition can vary widely and may be based on the particular needs of the intended consumer or the intended product form. In certain exemplary embodiments, fat is present in an amount of 3 g to 15 g per serving (e.g., approximately 8 oz. or 237 ml) of the nutritional composition. In certain exemplary embodiments, fat is present in an amount of 5 g to 15 g per 237 ml serving of the nutritional composition. In certain exemplary embodiments, fat is present in an amount of 5 g to 12 g per 237 ml serving of the nutritional composition. In certain exemplary embodiments, fat is present in an amount of 6 g to 10 g per 237 ml serving of the nutritional composition. In certain exemplary embodiments, fat is present in an amount of from 3 to less than 8 g per serving of the nutritional composition. In certain exemplary embodiments, fat is present in an amount of about 0.04 g per ml of the nutritional composition.

Carbohydrate

The nutritional compositions described herein include a source or sources of carbohydrate. Any carbohydrate source that is suitable for use in oral liquid nutritional compositions and is compatible with the essential elements and features of such compositions is suitable for use herein. Exemplary sources of the carbohydrate include, but are not limited to, maltodextrin, hydrolyzed or modified starch, hydrolyzed or modified cornstarch, glucose polymer, corn syrup, corn syrup solids, rice-derived carbohydrate such as rice maltodextrin, brown rice milk powder and brown rice syrup, sucrose, glucose, fructose, lactose, honey, sugar alcohol (e.g., maltitol, erythritol, sorbitol), isomaltulose, sucromalt, pullulan, potato starch, slowly-digested carbohydrates, dietary fibers, including but not limited to, oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low and high methoxy pectin, cereal beta-glucanssuch as oat beta-glucan and/or barley beta-glucan, carrageenan, psyllium, Fibersol™, fruit puree, vegetable puree, isomalto-oligosaccharides, monosaccharides, disaccharides, glucose polymers such as polydextrose and dextrins, tapioca-derived carbohydrates fructooligosaccharides, inulin, other resistant starches, and artificial sweetener, or a combination of two or more thereof.

The amount of carbohydrate present in the nutritional composition can vary widely and may be based on the particular needs of the intended consumer or the intended product form. In certain exemplary embodiments, carbohydrate is present in an amount of 15 g to 50 g per serving (e.g., approximately 8 oz. or 237 ml) of the nutritional composition. In certain exemplary embodiments, carbohydrate is present in an amount of 15 g to 40 g per 237 ml serving of the nutritional composition. In certain exemplary embodiments, carbohydrate is present in an amount of 25 g to 40 g per 237 ml serving of the nutritional composition. In certain exemplary embodiments, carbohydrate is present in an amount of from 15 to less than 35 g per 237 ml serving of the nutritional composition. In certain exemplary embodiments, carbohydrate is present in an amount of about 0.1 to 0.2 g per mL of the nutritional composition.

It will be apparent to those skilled in the art that the nutritional compositions of the invention may comprise various combinations of the described protein, fat and carbohydrate components, in various amounts within the ranges described above. In specific non-limiting embodiments, the nutritional compositions comprise from about 5 to 25 g protein, from about 3 to 15 g fat, and from about 15 to 50 g carbohydrate per 237 ml. In additional specific non-limiting embodiments, the nutritional compositions comprise from about 5 to 15 g protein, from about 3 to 8 g fat, and from about 15 to 35 g carbohydrate per 237 ml. In further specific embodiments, the source of protein comprises milk protein concentrate, nonfat dry milk, and/or soy protein isolate, the source of fat comprises canola and/or corn oil, and the source of carbohydrate comprises maltodextrin and/or sugar (sucrose).

Green Tea Extract

Green tea extract comprising EGCg, a catechin polyphenol, as discussed previously, is desirable for many therapeutic and nutritional benefits. EGCg generally is the most abundant polyphenol present in green tea. The green tea extract may comprise EGCg alone, or in combination with other polyphenol compounds, including other catechins such as catechin (i.e., (+)-catechin, also known as “C”), epicatechin (“EC”), gallocatechin (“GC”), epigallocatechin (“EGC”), and epicatechin gallate (“ECg”); flavones such as apigenin, isoviloxin, sapotarin, and vicenin-2; flavonols such as kaempherol, quercetin, and myricetin; condensed flavanoids, and tannin glycosides. Accordingly, in certain embodiments, in addition to EGCg, the green tea extract further comprises at least one of C, EC, GC, EGC, ECg, and combinations of any two or more thereof. Examples of such suitable green tea extracts are in the form of a liquid, a solid (e.g., a powder), and mixtures thereof. Come commercially available green tea extracts are provided in the form of a powder and may conveniently be dissolved in water for use in the present compositions. In certain embodiments, the extract is decaffeinated such that it contains less than 1% by weight caffeine, or even less than 0.5% by weight caffeine. In certain embodiments, sources of EGCg other than green tea-based sources may also be utilized. These sources include, but are not limited to, oolong tea-based sources such as oolong tea, oolong tea extracts, and the like; white tea-based sources such as white tea, white tea extracts, and the like; macha tea, macha tea extracts, and the like; yellow tea, yellow tea extracts, and the like; and dark tea (i.e., Chinese dark tea), dark tea extracts, and the like.

In certain exemplary embodiments, the green tea extract contains at least 20% by weight EGCg. In other embodiments, the green tea extract contains at least 45% by weight EGCg. In certain exemplary embodiments, the green tea extract contains 20-100% by weight EGCg. In certain exemplary embodiments, the EGCg is provided as part of a green tea extract that contains 45-100% by weight EGCg, including 50-100% by weight EGCg, including 60-100% by weight EGCg, including 70-100% by weight EGCg, including 80-100% by weight EGCg, and also including 90-100% by weight EGCg. Examples of commercially available green tea extracts comprising EGCg include Teavigo® (>90% EGCg) and Sunphenon® 90D (>45% EGCg) (Taiyo International, Inc., Minneapolis, Minn.).

While the nutritional compositions of the invention may include green tea extract in any amount desirable, in certain embodiments, the compositions comprise from about 50 to 500 mg green tea extract per 237 ml serving. In more specific embodiments, the compositions comprise from about 200 to 400 mg, or, more specifically, from about 250 to 400 mg or from about 300 to 400 mg, green tea extract per 237 ml serving. In certain embodiments, the compositions comprise from about 25 to 300 mg EGCg per 237 ml serving. In more specific embodiments, the compositions comprise from about 25 to 200, or, more specifically, from about 25 to 110, mg EGCg, per 237 ml serving. One skilled in the art will appreciate that while the green tea extract may include greater amounts of EGCg upon addition to the composition, during processing and heat treatment of the composition, a portion of the EGCg may be converted to gallocatachingallate (GCg), so that the sterilized nutritional composition contains less EGCg than originally contained in the added green tea extract. In one embodiment, the nutritional composition comprises from about 300 to 400 mg green tea extract per 237 ml serving, and the green tea extract, upon addition to the composition, comprises at least 20 wt % EGCg.

Insoluble Iron Source

As discussed previously, addition of green tea extract, or specifically, EGCg, to an off-white colored nutritional composition, for example, a vanilla-flavored composition, also containing iron fortification can cause the composition to turn from an off-white color to a purple or red color. The discoloration often increases when the composition is heat treated, for example, during processing and/or aseptic or retort sterilization. It has been discovered that soluble iron components such as ferrous sulfate typically used for iron fortification to provide better iron bioavailability significantly accelerate the product discoloration resulting from EGCg in neutral pH nutritional compositions. The nutritional compositions of the invention further include an insoluble source of iron comprising at least one of ferric orthophosphate and ferric pyrophosphate. Surprisingly, this type of insoluble iron source provides iron fortification to the nutritional compositions without the EGCg-related discoloration often observed in prior art products and maintains the off-white product color. These improvements are obtained without negatively affecting other properties of the nutritional compositions, even in heat treated compositions, i.e., compositions subjected to sterilization by aseptic or retort methods. For example, the ferric orthophosphate and ferric pyrophosphate do not form noticeable precipitates in the liquid compositions or otherwise interfere with the pleasing mouth feel and taste of the compositions.

The ferric orthophosphate and/or ferric pyrophosphate is included in the nutritional compositions to provide the compositions with nutritional iron fortification. In specific embodiments, the nutritional compositions comprise from about 6 to 60 mg of ferric orthophosphate and/or ferric pyrophosphate per 237 ml serving. In additional embodiments, the nutritional compositions comprise from about 6 to 30 mg, or more specifically, from about 6 to 20 mg, of ferric orthophosphate and/or ferric pyrophosphate per 237 ml serving. In specific embodiments, the ferric orthophosphate and/or ferric pyrophosphate is included in the nutritional compositions in an amount sufficient to provide about 1.8 to 18 mg iron, or, more specifically, about 1.8 to 6 mg iron, per 237 ml serving. The iron fortification is provided while avoiding unacceptable discoloration of an off-white product, for example a vanilla or banana flavored composition, or other flavor normally associated with an off-white or light color. In additional embodiments of the nutritional compositions, the compositions are substantially free of soluble iron components and, in more specific embodiments, the compositions contain less than about 1 mg/kg of soluble iron.

The nutritional composition's resistance to discoloration is quantified using the Hunter color scale parameters. The Hunter color scale is a three-variable scale, using variables L, a, and b, developed to quantify color and to numerically communicate differences in color between two or more materials. The maximum value of the variable L is 100, which represents a perfectly reflecting substrate (e.g., white). The minimum for L is zero and corresponds to black. The a and b values have no specific numerical limits. Positive values for a represent red, whereas negative values for a represent green. Positive values for b represent yellow and negative values for b represent blue. Delta E is a numerical value that is used in conjunction with the Hunter a, b, and L values to provide a single numerical description for the difference between two colors (or one color and a standard).

In the nutritional compositions of the invention, the ferric orthophosphate and/or ferric pyrophosphate are included in an amount effective to provide the composition with a Hunter L value not less than 60, i.e., to substantially maintain the off-white color of the composition in the presence of the green tea extract. In specific embodiments, the sterilized nutritional composition has a Hunter L value not less than 65, not less than 70, or not less than 75, or, even more specifically, not less than 80. Such Hunter L values indicate that the nutritional composition resists significant discoloring. In additional embodiments, the nutritional composition has a Hunter a value within the range of −10 to 10, or more specifically, in a range of 1 to 10, or in a range of 5-6, and a Hunter b value within the range of −5 to 25, or more specifically, in a range of 5 to 20, or a range of 9-16.

Optional Ingredients

In certain exemplary embodiments, the nutritional composition may further comprise other optional ingredients that may modify its physical, chemical, hedonic, or processing characteristics or serve as pharmaceutical or additional nutritional components when used in a targeted population. Many such optional ingredients are known or otherwise suitable for use in other nutritional compositions and may also be used in the nutritional compositions described herein, provided that such optional ingredients are safe and effective for oral administration and are compatible with the essential and other ingredients in the selected product form.

In certain exemplary embodiments, the nutritional composition further comprises any of a variety of vitamins or related nutrients, non-limiting examples of which include vitamin A, vitamin D, vitamin E, vitamin K, thiamine, riboflavin, vitamin B6, vitamin B12, niacin, folic acid, pantothenic acid, biotin, vitamin C, choline, inositol, salts and derivatives thereof, and combinations thereof.

In certain exemplary embodiments, the nutritional composition further comprises any of a variety of minerals, non-limiting examples of which include phosphorus, magnesium, calcium, manganese, sodium, potassium, molybdenum, chromium, selenium, chloride, iodide, and combinations thereof.

In certain exemplary embodiments, the nutritional composition may be an “excellent source of” (as defined by the Food and Drug Administration (US FDA)) at least one of the following: calcium, riboflavin, vitamin B6, folate, pantothenic acid, phosphorous, iodine, selenium, manganese, chromium, molybdenum, and combinations thereof.

In certain exemplary embodiments, the nutritional composition may be a “good source of” (as defined by the US FDA) at least one of the following: vitamin A, vitamin C, vitamin E, thiamin, niacin, biotin, and combinations thereof.

In certain exemplary embodiments, the nutritional composition comprises at least one sweetening agent. Various sweetening agents are discussed above in connection with the carbohydrate component. In certain exemplary embodiments, the at least one sweetening agent is a sugar alcohol such as maltitol, erythritol, sorbitol, xylitol, mannitol, isolmalt, lactitol, and combinations thereof, or at least one artificial or high potency sweetener such as acesulfame K, aspartame, sucralose, saccharin, stevia, tagatose, monk fruit, and combinations thereof.

In certain exemplary embodiments, the nutritional composition comprises a stabilizer. Any stabilizer that is known or otherwise suitable for use in a nutritional composition may be suitable for use herein, some non-limiting examples of which include gums such as carrageenan and xanthan gum.

In certain exemplary embodiments, the nutritional composition comprises one or more masking agents to reduce or otherwise obscure the effects of any bitter flavors and after taste that may develop in the nutritional composition over time. Suitable masking agents include natural and artificial sweeteners, sodium sources such as sodium chloride, and combinations thereof. The amount of masking agent added to the nutritional composition may vary depending upon the particular masking agent selected, other ingredients in the formulation, and other formulation or product target variables.

In certain exemplary embodiments, the nutritional compositions may optionally contain one or more amino acids and/or branched-chain amino acids, including, but not limited to, arginine, glutamine, leucine, isoleucine and/or valine, and/or metabolites thereof such as alpha-hydroxyisocaproic acid (HICA), α-ketoisocaproate (KIC), and beta-hydroxy-beta-methylbutyrate (HMB). In specific embodiments, the nutritional compositions may comprise from about 0.01 to about 10 wt % amino acids and/or branched-chain amino acids. In a more specific embodiment, the nutritional compositions comprise from about from about 0.1% to 7.0%, or more specifically, from about 0.1% to 5.0%, amino acids and/or branched-chain amino acids. In further embodiments, the nutritional compositions provide from about 0.5 to 5 grams, or more specifically, from about 1 to 3 grams, amino acids and/or branched-chain amino acids, per 237 ml serving. In a more specific embodiment, the nutritional compositions provide from about 0.5 to 5 grams, or more specifically, from about 1 to 3 grams, leucine and/or metabolites of leucine, per 237 ml serving.

In certain exemplary embodiments, the nutritional compositions contain beta-hydroxy-beta-methylbutyrate (HMB). HMB is a naturally occurring short chain fatty acid metabolite of leucine that is known for use in a variety of nutritional products and supplements. Any source of HMB is suitable for use herein, including, but not limited to, the free acid, a salt, including an anhydrous salt, an ester, a lactone, or other product forms that otherwise provide a bioavailable form of HMB in the nutritional composition. Non-limiting examples of suitable salts of HMB for use herein include HMB salts, hydrated or anhydrous, of sodium, potassium, magnesium, chromium, calcium, or other non-toxic salt form. In a specific embodiment, the HMB is provided by calcium HMB monohydrate. In specific embodiments, the nutritional compositions may comprise from about 0.01 to 10 wt % HMB. In a more specific embodiment, the nutritional compositions comprise from about from about 0.1% to 7.0%, or more specifically, from about 0.1% to 5.0%, HMB. In further embodiments, the nutritional compositions provide from about 1 to 3 grams, or more specifically, from about 1.5 to 3 grams, HMB per 237 ml serving.

Non-limiting examples of other optional ingredients include fiber, preservatives, antioxidants, emulsifying agents, buffers, colorants, flavors, probiotics, prebiotics, thickening agents, and so forth.

Methods of Manufacture

Generally, the nutritional compositions, whether in liquid form or reconstituted from powder form, may be manufactured by any known or otherwise suitable method for making such compositions.

In a specific embodiment, the nutritional composition is manufactured in liquid form, and, more specifically, in an emulsion form, including, but not limited to a milk-based nutritional emulsion. In one suitable manufacturing process, a nutritional liquid is prepared using at least three separate slurries, including a protein-in-fat (PIF) slurry, a carbohydrate-mineral (CHO-MN) slurry, and a protein-in-water (PIW) slurry. The PIF slurry is formed by heating and mixing the selected oils (e.g., canola oil, corn oil, etc.) and then adding an emulsifier (e.g., lecithin), fat soluble vitamins, and a portion of the total protein (e.g., milk protein concentrate, etc.) with continued heat and agitation. The CHO-MN slurry is formed by adding to water, with heated agitation, minerals (e.g., potassium citrate, dipotassium phosphate, sodium citrate, etc.), trace minerals (TM) and ultra trace minerals (UTM) premix (typically including the ferric pyrophosphate and/or ferric orthophosphate), and thickening or suspending agents (e.g. microcrystalline cellulose (for example, Avicel®), gellan, carrageenan). The resulting CHO-MIN slurry is held for 10 minutes with continued heat and agitation before adding additional minerals (e.g., potassium chloride, magnesium carbonate, potassium iodide, etc.) and/or carbohydrates (e.g., fructooligosaccharide, sucrose, corn syrup, etc.). The PIW slurry is formed by mixing with heat and agitation the remaining protein (e.g., sodium caseinate, soy protein concentrate, etc.) into water.

The resulting slurries are then blended together with heated agitation and the pH adjusted to the desired neutral range, typically from 6.6-7.0, after which the composition is subjected to high-temperature short-time (HTST) processing during which the composition is heat treated, emulsified and homogenized, and then allowed to cool. Water soluble vitamins and ascorbic acid are added, the pH is again adjusted to the desired range if necessary, flavors are added, and water is added to achieve the desired total solid level (typically 20-40 wt %). In a specific embodiment, the green tea extract is added at about the same time, i.e., before, with or after, the flavor components. For example, green tea extract in powder form may be dissolved in water and added as a thoroughly mixed solution. The composition is then either aseptically packaged to form an aseptically packaged liquid emulsion nutritional composition, or the composition is added to retort stable containers and then subjected to retort sterilization to form a retort sterilized liquid emulsion nutritional composition. In both aseptic and retort heating processes, such as those employed in sterilization of nutritional compositions, temperatures from about 80° F. to about 220° F. (about 27° C. to about 104° C.) may be employed. In other, non-limiting examples, the high protein nutritional composition can be treated with heat at a temperature in a range from about 85° F. to about 95° F. (about 29° C. to about 35° C.), from about 130° F. to about 150° F. (about 54° C. to about 66° C.), from about 165° F. to about 185° F. (about 74° C. to about 85° C.), and/or from about 208° F. to about 215° F. (about 98° C. to about 102° C.).

The manufacturing processes for the nutritional emulsions may be carried out in ways other than those set forth herein without departing from the spirit and scope of the present disclosure. The present embodiments are, therefore, to be considered in all respects illustrative and not restrictive, and changes and equivalents of the described processes also come within the description of the present disclosure.

### EXAMPLE

This Example demonstrates an improved liquid nutritional composition according to the invention.

Four samples of a vanilla-flavored nutritional composition comprising protein (milk protein concentrate, soy protein isolate and nonfat milk), fat (a blend of corn and canola oils) and carbohydrate (corn maltodextrin and sucrose) as set forth in the following Table 1 were employed in this example.

TABLE 1

| Ingredient | Amount/1000 kg | |
|---|---|---|
| Water | Q.S. | |
| Corn Maltodextrin | 72.5 | kg |
| Sucrose | 54.4 | kg |
| Milk Protein Concentrate | 24.6 | kg |
| Canola Oil | 17.5 | kg |
| Soy Protein Isolates | 16.9 | kg |
| Corn Oil | 5.8 | kg |
| Nonfat Dry Milk | 5.0 | kg |
| Phosphates | 3.8 | kg |
| Citrates | 3.2 | kg |
| Avicel CL-611 | 2.4 | kg |
| Flavorings and Sweeteners | 2.8 | kg |
| Chlorides | 1.9 | kg |
| Calcium Carbonate | 1.0 | kg |
| Ascorbic Acid | ~500 | g |
| Trace Mineral Premix | ~400 | g |
| Potassium Hydroxide Solution | ~325 | g |
| Emulsifiers | ~800 | g |
| Water Soluble Vitamin Premix | ~70 | g |
| Oil Soluble Vitamin Premix | ~60 | g |
| Misc. vitamins and additives | ~1 | kg |

Sample 1 was supplemented with a conventional soluble iron source, ferrous sulfate, and 350 mg per 237 ml of green tea extract (Sunphenon 90D). Sample 2 was supplemented with 350 mg per 237 ml of the green tea extract and had no added iron. Sample 3 was supplemented with a ferric orthophosphate as the iron source and 350 mg per 237 ml of green tea extract. Sample 4 was supplemented with Lipofer (a micronized lecithin encapsulated ferric pyrophosphate) as the iron source and 350 mg per 237 ml of green tea extract. Samples 1, 3 and 4 also included copper sulfate.

FIG. 1 shows the respective products and demonstrates that Sample 3, a liquid nutritional composition according to the invention, resists any significant discoloration as compared with Sample 2, containing green tea extract but no iron fortification, despite the inclusion in Sample 3 of both green tea extract and iron fortification. On the other hand, Sample 1, including conventional iron fortification in the form of ferrous sulfate, exhibited significant discoloration to a brick red color, incongruent with the vanilla flavored product. Finally, Sample 4, containing Lipofer, in which the ferric pyrophosphate is encapsulated, surprisingly also showed some discoloration relative to Sample 2, but significantly less than that of Sample 1.

Retort sterilized samples were tested for soluble iron by centrifugation at 30,100×g and 20° C. for 2 hours. The results were as follows:

| Sample | Fortification | Soluble Iron, mg/kg |
|---|---|---|
| 1 | ferrous sulfate + green tea extract | 3.57 |
| 2 | green tea extract | 0.60 |
| 3 | ferric orthophosphate + green tea extract | 0.63 |
| 4 | Lipofer + green tea extract | 1.30 |

The retort sterilized samples were tested for EGCg, GCg, ECg and Cg content, and the results were as follows, per 250 gram sample:

| Sample | EGCg | GCg | ECg | Cg |
|---|---|---|---|---|
| 1 | 47.1 | 73.8 | 7.76 | 12.4 |
| 2 | 43.4 | 70.3 | 7.62 | 12.1 |
| 3 | 42.6 | 68.6 | 7.36 | 11.8 |
| 4 | 43.0 | 69.4 | 7.60 | 12.1 |

The retort sterilized samples were stored under ambient conditions for 6 months and then evaluated according to the Hunter color scale (ColorFlex 45/0, mode-reflectance). The results were as follows:

| Sample | L Value | a Value | b Value |
|---|---|---|---|
| 1 | 44.63 | 6.53 | 4.14 |
| 2 | 63.19 | 5.67 | 13.98 |
| 3 | 60.71 | 5.99 | 11.96 |
| 4 | 49.00 | 6.98 | 6.15 |

The Hunter color scale measurements show that Sample 3 according to the invention, containing both green tea extract and iron fortification in the form of ferric orthophosphate, exhibited good color stability, with the L, a and b values approaching those of Sample 2, which contained green tea extract but no iron fortification. On the other hand, Sample 1, including conventional iron fortification in the form of ferrous sulfate, exhibited significant discoloration as measured by the L value, as well as by the a and b values, although to a lesser extent. Finally, Sample 4, containing Lipofer, in which the ferric pyrophosphate is encapsulated, also showed significant discoloration as measured by the L value, relative to Sample 2, as well as by the a and b values, although to a lesser extent. These results demonstrate the improved resistance to discoloration provided by the inventive compositions.

The examples and specific embodiments set forth herein are illustrative in nature only and are not to be taken as limiting the scope of the invention defined by the following claims. Additional specific embodiments and advantages of the present invention will be apparent from the present disclosure and are within the scope of the claimed invention.

1. A sterilized liquid nutritional composition having an off-white color and a pH of from about 6 to 7.5 and comprising a source of protein, a source of fat, a source of carbohydrate, green tea extract comprising epigallocatechin gallate (EGCg), and an insoluble source of iron comprising at least one of ferric orthophosphate and ferric pyrophosphate, wherein the composition comprises, per 237 ml serving, from about 50 to 500 mg green tea extract and from about 6 to 60 mg ferric orthophosphate and/or ferric pyrophosphate, and wherein the composition has a Hunter L value not less than 60.

2. The composition of claim 1, wherein the composition has a Hunter L value not less than 65, not less than 70, or not less than 75.

3. The composition of claim 1, wherein the composition has a Hunter a value within the range of −10 to 10, and a Hunter b value within the range of −5 to 25.

4. The composition of claim 1, comprising from about 25 to 300 mg EGCg.

5. The composition of claim 1, comprising from about 6 to 60 mg of ferric orthophosphate and/or ferric pyrophosphate per 237 ml serving.

6. The composition of claim 1, comprising from about 1.8 to 18 mg of iron per 237 ml serving.

7. The composition of claim 1, wherein the composition contains less than about 1 mg/kg of soluble iron.

8. The composition of claim 1, comprising from about 200 to 400 mg green tea extract per 237 ml serving.

9. The composition of claim 1, comprising from about 250 to 400 mg green tea extract per 237 ml serving.

10. The composition of claim 1, comprising from about 300 to 400 mg green tea extract per 237 ml serving, wherein the green tea extract upon addition to the composition, comprises at least 20 wt % EGCg.

11. The composition of claim 1, wherein the composition comprises from about 5 to 25 g protein, from about 3 to 15 g fat, and from about 15 to 50 g carbohydrate per 237 ml, or comprises from about 5 to 15 g protein, from about 3 to 8 g fat, and from about 15 to 35 g carbohydrate per 237 ml.

12. The composition of claim 1, wherein a source of the protein comprises whole egg powder, egg yolk powder, egg white powder, whey protein, whey protein concentrate, whey protein isolate, whey protein hydrolysate, acid casein, casein protein isolates, sodium caseinate, calcium caseinate, potassium caseinate, casein hydrolysate, milk protein concentrate, milk protein isolate, milk protein hydrolysate, nonfat dry milk, whole cow's milk, partially or completely defatted milk, coconut milk, soy protein concentrate, soy protein isolate, soy protein hydrolysate, pea protein concentrate, pea protein isolate, pea protein hydrolysate, rice protein concentrate, rice protein isolate, rice protein hydrolysate, collagen protein, collagen protein hydrolysate, beef protein isolate, chicken protein isolate, or a combination of two or more thereof.

13. The composition of claim 1, wherein a source of the fat comprises whole egg powder, egg yolk powder, egg white powder, coconut milk, coconut oil, fractionated coconut oil, soy oil, corn oil, butter oil, olive oil, safflower oil, high oleic safflower oil, high gamma-linolenic acid safflower oil medium chain triglycerides, sunflower oil, high oleic sunflower oil, palm oil, palm kernel oil, palm olein, canola oil, algae oil, borage oil, marine oil, fish oil, cottonseed oil, a structured lipid, any of said oils in powder form, or a combination of two or more thereof.

14. The composition of claim 1, wherein a source of the carbohydrate comprises maltodextrin, hydrolyzed or modified starch, hydrolyzed or modified cornstarch, glucose polymer, corn syrup, corn syrup solids, rice-derived carbohydrate, sucrose, glucose, fructose, lactose, honey, sugar alcohol, artificial sweetener, dietary fiber, or a combination of two or more thereof.

15. The composition of claim 1, wherein the source of protein comprises milk protein concentrate, nonfat dry milk, and/or soy protein isolate, the source of fat comprises canola and/or corn oil, and the source of carbohydrate comprises maltodextrin and/or sugar.

16. The composition of claim 1, wherein the composition comprises from about 0.5 to 5 grams amino acids and/or branched-chain amino acids, per 237 ml serving.

17. The composition of claim 1, wherein the composition comprises from about 0.5 to 5 grams leucine and/or metabolites of leucine, per 237 ml serving.

18. The composition of claim 1, wherein the composition comprises from about 1 to 3 grams beta-hydroxy-beta-methylbutyrate (HMB), per 237 ml serving.

19. The nutritional composition of claim 18, wherein the HMB is provided as calcium HMB monohydrate.

20. The composition of claim 1, wherein the composition has been reconstituted from a powder.
